(19) United States
(12) Patent Application Publication
(10) Pub. No.: US 2009/0010507 A1
(43) Pub. Date: Jan. 8, 2009

(54) SYSTEM AND METHOD FOR GENERATING A 3D MODEL OF ANATOMICAL STRUCTURE USING A PLURALITY OF 2D IMAGES

(76) Inventor: Zheng Jason Geng, Rockville, MD (US)

Correspondence Address: THORPE NORTH & WESTERN, LLP., P.O. Box 1219, SANDY, UT, 84091-1219, US

(21) Appl. No.: 12/167,189

(22) Filed: Jul. 2, 2008

Related U.S. Application Data
(60) Provisional application No. 60/947,581, filed on Jul. 2, 2007.

(51) Int. Cl. G06K 9/00

(52) U.S. Cl. 382/128

(57) ABSTRACT

A system and method are provided for generating a three dimensional (3D) model of an anatomical structure of a patient using a plurality of two dimensional (2D) images acquired using a camera. The method includes the operation of searching the plurality of 2D images to detect correspondence points of image features across at least two images. Camera motion parameters can be determined using the correspondence points for a sequence of at least two images taken at different locations by the camera moving within the internal anatomical structure. A further operation is computing dense stereo maps for 2D image pairs that are temporally adjacent. A consistent 3D model can be formed by fusing together multiple 2D images which are applied to a plurality of integrated 3D model segments. Then the 3D model of the patient's internal anatomical structure can be displayed to a user on a display device.

### CLAIM OF PRIORITY

Priority of U.S. Provisional patent application Ser. No. 60/947,581 filed on Jul. 2, 2007 is claimed.

### BACKGROUND

Every year, diseases of the gastrointestinal (GI) tract account for more than 30 million office visits in the United States alone. GI tract disorders are easy to cure in their early stages but can be difficult to diagnose.

Recent advances in imaging sensor technologies have lead to a new generation of endoscopic devices such as video endoscopes and in-vivo capsule cameras which may use a swallowable pill-size miniature wireless video camera to image and diagnose conditions associated with the gastrointestinal (GI) tract. This technology not only offers a generally painless examination experience for patients but can also be quite successful in acquiring video images for areas difficult to reach by traditional endoscopic devices (e.g., small intestine). Of course, other internal organs can also be examined using endoscopic cameras and devices.

An in-vivo capsule camera can capture two or more high quality images per second during the camera's 8+ hour journey, and thus provide a huge set of still video images for each internal examination (e.g., 57,600 images per examination). As a result, this type of technology presents significant technical challenges surrounding how to efficiently process the huge amount of video images and how to extract and accurately present clinically useful information to a physician.

Reviewing acquired video images is a tedious process and can use 2 hours or more of physician's time to complete. Manually searching all the acquired 2D images for a potential disease is a time-consuming, tedious, difficult, and error prone task due to the large number of images per case. Even if a suspicious area is found in an internal organ, determining its actual location within a patient body's is difficult and the physician may need to rely memory or rough notes in order to perform an operation.

### BRIEF DESCRIPTION OF THE DRAWINGS

FIG. 1 is a block diagram illustrating a processing framework for converting 2D images into a 3D structure in accordance with an embodiment of the present invention;

FIG. 2 is a perspective diagram illustrating a camera model and projection of 3D points for a moved camera in accordance with an embodiment of the present invention;

FIG. 3 is a flowchart illustrating major computational methods for recovering camera motion and sparse 3D structure in accordance with an embodiment;

FIG. 4 illustrates the use of epipolar geometry to search for correspondence points in an embodiment of the invention;

FIG. 5 illustrates the use of epipolar geometry for recovery of sparse 3D structure points in an embodiment;

FIG. 6 is a flowchart illustrating operations used for generating dense 3D pieces from a sequence of 2D images in an embodiment of the invention;

FIG. 7 is a graph illustrating the SSD (Sum of Squared Difference)/SSSD (Stereo Sum of Squared Difference) and localized computation zone defined by point tracking and epipolar constraints in an embodiment;

FIG. 8 is a flowchart and graphical representation of an embodiment of an iterative fine alignment optimization method;

FIG. 9 illustrates major functional components of a system for processing 2D video to a 3D environment;

FIG. 10 illustrates groupings of functional components used in the system for generating a three dimensional (3D) model of an anatomical structure of a patient using a plurality of two dimensional (2D) images; and

FIG. 11 is flowchart illustrating for generating a three dimensional (3D) model of an anatomical structure of a patient using a plurality of two dimensional (2D) images acquired using a camera.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Thousands of still images can be acquired from a capsule camera or endoscope during an internal examination of a patient using current imaging systems. However, current image processing software tools are not able to provide a three-dimensional (3D) model of an internal organ (e.g., GI tract) reconstructed from the thousands of images (e.g., over 57,000 images) acquired by a capsule camera.

Reviewing the acquired still images is a tedious process and involves about 2 hours of physician's time to complete, due to large number of images that need to be studied. Unfortunately, there has been a lack of powerful image processing and visualization software to aid with this task. Without a computer-aided image analysis software tool that is available to a physician, it can be difficult to find diseased areas quickly and perform quantitative analysis of the target images for the patient's organ.

Even if a suspicious structure is found, determining the structure's location within a patient's body for performing surgery is difficult, since there is no reliable map of the internal organ that can be relied upon. For example, there has been no 3D model of a GI tract when a GI exam is given with a capsule camera. 3D sizing of pathological structures is also clinically important to determine the degree and stage of disease, but no existing software provides such capability.

A system and method are provided in this disclosure for converting still video images from a moving camera into a 3D model and environment that can be interacted with in real-time by a user using a video display. The method is capable of automatically producing an integrated, patient-specific, and quantitatively measurable model of the internal organs of a human patient. This method significantly improves on current endoscopic diagnosis procedures and in-vivo capsule camera technology by providing the capability of 3D anatomical modeling, 3D fly-through visualization, 3D measurement of pathological structures and 3D localization of a target area with respect to a patient's body for diagnosis and intervention planning.

The 3D model can be created by inter-correlating over 57,000 images acquired by a capsule camera to reconstruct a high resolution patient-specific 3D model of a patient's internal systems or organs. The images may be acquired from the gastrointestinal tract, respiratory tract, reproductive tract, urinary tract, the abdomen, joints, or other internal anatomical areas into where an endoscope or capsule camera may be used. For example, a model can be created for a gastrointestinal (GI) tract 3D model based upon the 2D video still image sequence acquired by an endoscope or a capsule camera during an exam.

The system and method also provides 3D visualization at a level that has been previously unavailable. Texture super-resolution is provided along with a 3D fly-through capability for 3D models of internal organs to help physicians to interactively visualize and accurately and efficiently diagnose problems.

In addition to the valuable visualization provided by the present system and method, quantitative mapping and measurements can also be determined. For example, 3D measurements can be made for pathological structures of interest. 3D localization can also be used to perform an accurate 3D intra-body location of targets within a patient's body.

Reliable analysis of image sequences captured by uncalibrated (i.e., freely moving) cameras is arguably one of the most significant challenge in computational geometry and computer vision. This system and method is able to build an accurate 3D model of patient-specific anatomy (e.g., GI tract) automatically based upon 2D still images acquired by a capsule camera during each examination. The obtained 3D model can then be used by a physician to quickly diagnose morbidity of anatomical structures via a fly-through 3D visualization tool and 3D measurement capability. The 3D model of the anatomical structures can also aid in locating particular areas of interest with respect to the physical anatomy being studied.

The present system and method follows a “feature-based” approach toward uncalibrated video image sequence analysis, in contrast with the intensity-based direct methods which consider the information from all the pixels in the image. Video images are acquired by a free-moving capsule camera inside the anatomical structure (e.g., GI tract) during the exam. Neither the camera motion nor a preliminary model of the anatomical structure has to be known a priori.

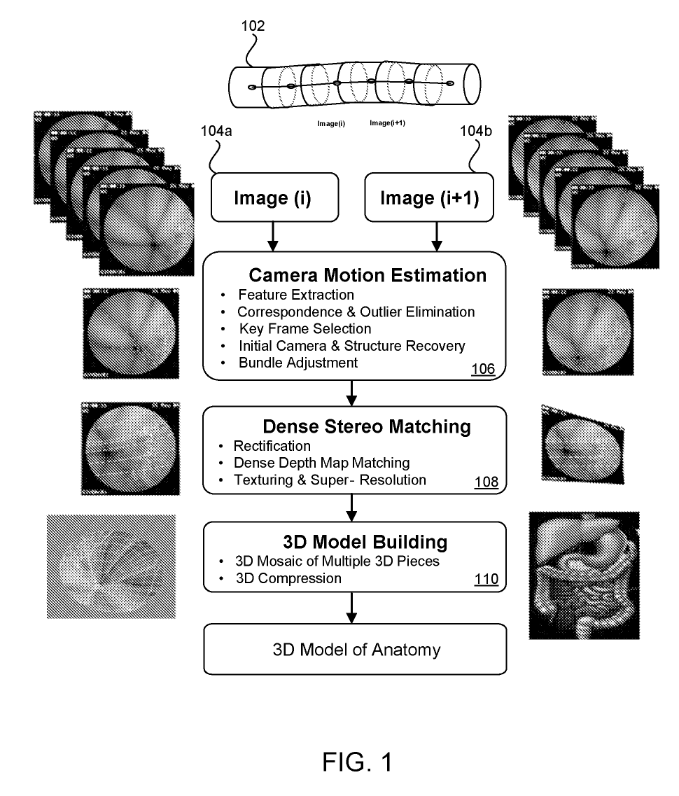

Given an image sequence 102, salient features are extracted first from each frame (104a, 104b) and the features are tracked across frames to establish correspondences. Camera motion parameters are estimated from correspondences 106. Dense stereo maps are then computed between adjacent image pairs 108. Multiple 3D maps are linked together by fusing all images into a consistent 3D model 110. FIG. 1 shows these main processing modules.

In order to deal more efficiently with video, the system and method uses an approach that can automatically select key-frames suited for structure and motion recovery.
To provide a maximum likelihood of reconstruction at the different levels, the system implements a bundle adjustment algorithm at both the projective and the Euclidean level.
Since certain intrinsic parameters of a capsule camera are known a priori, a more robust linear self-calibration algorithm can be used that incorporates a priori knowledge on meaningful camera intrinsic properties to avoid many of the problems related to critical motion sequences (i.e., some motions do not yield a unique solution for the calibration of the intrinsic properties). Previous linear algorithms often yield poor results under these circumstances.
For the bundle adjustment, both correction for radial distortion and stereo rectification are integrated into a single image re-sampling pass in order to minimize the image degradation.
The processing pipeline can also use a non-linear rectification scheme to deal with all types of camera motion (including forward motion).
A volumetric approach is used for the integration of multiple 3D pieces into a consistent 3D model.
The texture is obtained by blending original images based on surface geometry to optimize texture quality.
   With these features, the resulting system is robust, accurate and computationally efficient, suited for GI tract 3D modeling as well as many other biomedical imaging applications.

### Camera Motion Estimation

There are two typical cases that can exist when using multiple images to obtain 3D information. The first case is stereo acquisition where 3D information is obtained from multiple images acquired simultaneously. The second case is motion acquisition where 3D information is obtained from multiple images acquired sequentially. In other words, the multiple viewpoints can be a stereo image pair or a temporal image pair. In the latter case, the two images are taken at different times and locations with the camera moving between image acquisitions, such as a capsule camera used in a GI exam. It is possible to reconstruct some very rich non-metric representations (i.e., the projective invariants) of the 3D environment. These projective invariants can be used to estimate camera parameters using only the information available in the images taken by that camera. No calibration frame or known object is needed. The basic parameters are that there is a static object in the scene, and the camera moves around taking images. There are three intertwined goals:
1. Recovery of 3D Structure: Recover the 3D position of scene structure from corresponding points matching.
2. Motion Recovery: Compute the motion (rotation and translation) of the camera between the two views.
3. Correspondence: Compute points in both images corresponding to the same 3D point.

### Camera Model

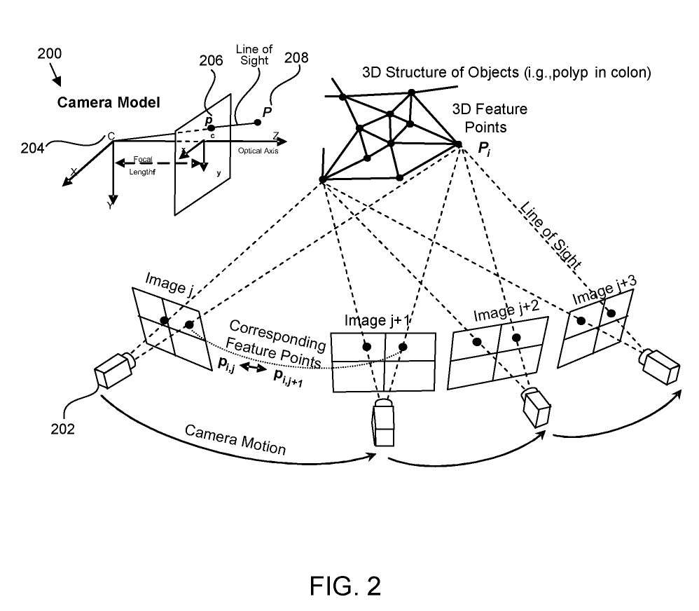

The geometric information that relates two different viewpoints of the same scene is entirely contained in a mathematical construct known as the fundamental matrix, which can be calculated from image correspondences, and this is then used to determine the projective 3D structure of the imaged scene. To recover camera motion parameters from a video sequence, a real camera 202 can be represented by a mathematical camera model 200 in FIG. 2. The “pin-hole” camera model describes the projection of a 3D point P 208 to the image coordinate p 206 through a perspective camera 204 (upper left corner of FIG. 2). Using homogeneous representation of coordinates, a 3D feature point is represented as P=(X,Y,Z,1)^{T} and a 2D image feature point as p=(x,y,1)^{T}. A shift of optical center and the third order radial lens distortions are also taken into account.

The notation p_{i,j} is used to represent the projection of a 3D feature point Pᵢ in the j-th image (see FIG. 2), with

p_{i,j}=Kⱼ[Rⱼ|tⱼ]Pᵢ=AⱼPᵢ ∀j ∈ {1, . . . ,J},i ∈ {1, . . . ,I}, (1)

where K=[f s u;0 f v;0 0 1] is the calibration matrix,
containing internal camera parameters, Rⱼ is the rotation matrix, tⱼ is the translation vector, and Aⱼ is the camera matrix of the j-th position.

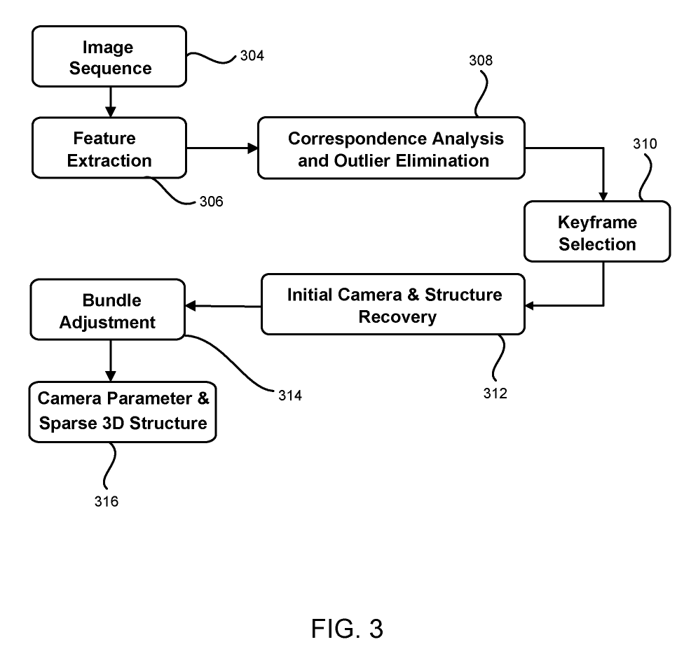

The camera motion estimation software module for estimation of Aⱼ and Pⱼ can include a number of processing steps, as shown in FIG. 3. Each processing step is described briefly in the following discussion. In order to begin the process, a sequence of images can be obtained by the capsule camera or endoscopic imaging equipment, as in block 304. Examples of capsule camera images can be seen in FIG. 1 to illustrate some examples of technical approaches.

In order to build an accurate 3D model of an anatomical structure, a highly accurate point-to-point correspondence (i.e., registration) between multiple 2D images captured by an unregistered “free-hand” capsule camera can be found so that camera motion parameters can be derived and a 3D piece of the anatomical surface can be quickly and accurately obtained. Furthermore, the accurate correspondence can also provide a foundation for the 3D anatomical model reconstruction and super-resolution.

Many image registration methods, especially those derived from the Fourier domain, are based on the assumption of purely translational image motion. Fast, accurate, and robust automated methods exist for registering images by affine transformation, bi-quadratic transformations, and planar projective transformations. Image deformations inherent in the imaging system, such as radial lens distortion may also be parametrically modeled and accurately estimated. In 3D modeling for capsule camera applications, however, far more demanding image transformations are processed on a regular basis. The image registration method can be improved based upon the KLT technique.

The KLT feature tracker (named after Kanade, Lucas, and Tomasi) is designed for tracking good feature points through a video sequence. This tracker is based on the early work of Lucas and Kanade and was developed fully by Tomasi and Kanade. Briefly, good features are located by examining the minimum eigenvalue of each 2 by 2 gradient matrix, and features are tracked using a Newton-Raphson method of minimizing the difference between the two windows. Denote the intensity function by I(x, y) and consider the local intensity variation matrix as:

$$Z = [ \begin{matrix}\frac{{\partial }^{2} I}{\partial {x}^{2}} & \frac{{\partial }^{2} I}{\partial x \partial y} \\ \frac{{\partial }^{2} I}{\partial x \partial y} & \frac{{\partial }^{2} I}{\partial {y}^{2}}\end{matrix} ]$$

A patch defined by a 25×25 window is accepted as a candidate feature if in the center of the window both eigenvalues of Z, λ₁ and λ₁, exceed a predefined threshold λ: min(λ₁, λ₂)>λ. Feature extraction is illustrated in FIG. 3 as block 306.

The feature points in list Lⱼ and Lⱼ₊₁ of two successive views are assigned by measuring normalized cross-correlation between 25×25 pixel windows surrounding the feature points. The correspondences are established for those feature points, which have the highest cross-correlation. This results in a list of correspondences L_{c}={q₁, . . . ,qᵢ, . . . q_{I}}, where qᵢ=(\tilde{p}_{i,j},\tilde{p}_{i,j+1})^{T} is a correspondence.

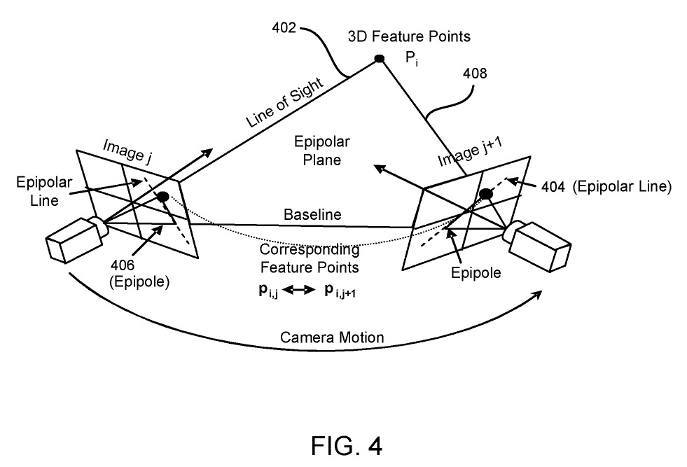

An important tool in the correspondence matching (308 of FIG. 3) is epipolar lines. FIG. 4 illustrates that when a feature is identified in one image, that feature is known to lie somewhere along the viewing ray 402. The viewing ray can be projected into the other image (j+1) 408. This forms a line 404 (an epipolar line) in the second image on which the feature we are trying to match will lie. All epipolar lines pass through the projection of the other image's projection center in the current image. This point is known as the epipole 406. Epipolar geometry greatly simplifies the problem of searching for correspondence points between two images from 2D search into 1D search problem (i.e., along the epipolar line).

The epipolar geometry captures the intrinsic geometry between the two images. This geometry is defined by the camera parameters with their relative pose, and it is independent of the structure of the scene. The geometric relation between the two images can be encapsulated in a 3×3 matrix known as the Fundamental Matrix, F. The epipolar constraint between two images can be defined as:

p_{i,j+1}^{T}Fp_{i,j}=0 Λi and det(F)=0 (2)

where F=Kⱼ₊₁^{-T}[tⱼ]ₓRKⱼ⁻¹ is the fundamental matrix (F-matrix). Given enough corresponding point matches, a set of equations is setup to solve for F. Note that F can only be determined up to a scale factor so eight matching points are sufficient. In fact only seven points are needed since F is only rank 2, but 7-points solution is nonlinear.

Using eight or more matched points we can set up the linear matrix equation

$$\begin{matrix}Af = [ \begin{matrix}{x}_{1 , j + 1} {x}_{1 , j} & {x}_{1 , j + 1} {y}_{1 , j} & {x}_{1 , j + 1} & {y}_{1 , j + 1} {x}_{1 , j} & {y}_{1 , j + 1} {y}_{1 , j} & {y}_{1 , j + 1} & {x}_{1 , j} & {y}_{1 , j} & 1 \\ ⋮ & ⋮ & ⋮ & ⋮ & ⋮ & ⋮ & ⋮ & ⋮ & ⋮ \\ {x}_{I , j + 1} {x}_{I , j} & {x}_{I , j + 1} {y}_{I , j} & {x}_{I , j + 1} & {y}_{I , j + 1} {x}_{I , j} & {y}_{I , j + 1} {y}_{I , j} & {y}_{I , j + 1} & {x}_{I , j} & {y}_{I , j} & 1\end{matrix} ] \\ [ \begin{matrix}{F}_{11} \\ {F}_{12} \\ {F}_{13} \\ {F}_{21} \\ {F}_{22} \\ {F}_{23} \\ {F}_{31} \\ {F}_{32} \\ {F}_{33}\end{matrix} ] \\ = 0\end{matrix} \\ ∀ j and det ( F ) = 0 \qquad ( 3 )$$

where f is a nine-element vector formed from the rows of F. Typically, several hundred of feature points will be automatically detected in each image with sub-pixel accuracy. Due to erroneous assignment of feature points arising from moving camera, usually some of the correspondences are incorrect. The F-matrix should be estimated using proper numerical computational tools by minimizing the residual error \tilde{e} of the Maximum Likelihood cost function for the used error model, consequently here:

$$\begin{matrix}{\tilde{e}}^{2} = \frac{1}{4 I} {\sum }_{i = 1}^{I} {d ( {\tilde{p}}_{i , j} , {\hat{p}}_{i , j} )}_{\sum }^{2} + {d ( {\tilde{p}}_{i , j + 1} , {\hat{p}}_{i , j + 1} )}_{\sum }^{2} \\ = \frac{1}{4 I} {\sum }_{i = 1}^{I} {e}_{i}^{2} ⇒ min\end{matrix} \qquad ( 4 )$$

subject to \hat{p}_{i,j} and \hat{p}_{i,j+1} fulfill exactly equation (2) for F-matrix, where d( . . . )_{Σ} denotes the Mahalanobis distance for the given covariance matrices. This is the 8-point algorithm for calculating the fundamental matrix F. In practice, the numerical issues are addressed and final adjustments are made to F to enforce the fact that it only has rank 2.

The correspondences are refined using a robust research procedure such as the RANSAC (Random Sample Consensus) algorithm. The RANSAC extracts only those features whose inter-image motion is consistent with homography. Finally, these inlying correspondences are used in a non-linear estimator which returns a highly accurate correspondence. The steps are summarized below:
1. Feature Extraction: Calculate interest point features in each image to sub-pixel accuracy based on the KLT technique.
2. Correspondences: Calculate a set of feature point matches based on proximity and similarity of their intensity (or color) neighborhoods.
3. RANSAC Robust Estimation: Repeat for I samples
   a. Select a random sample of 4 correspondences and computer for geometric transformation A;
   b. Calculate a geometric image distance error for each correspondence;
   c. Compute the number of inliers consistent with the calculated geometric transformation A, by the number of correspondences for which the distance error is less than a threshold.
   d. Choose the calculated transformation A with the largest number of inliers.
4. Optimization of the Transformation: Re-estimate the geometric transformation A from all correspondences classified as inliers, by maximizing the likelihood function.
5. Guided Matching: Further feature correspondences are now determined using the estimated transformation A to define a search region about the transferred point position.
   The Step 4 and 5 can be iterated until the number of correspondences is stable. These operations are illustrated by block 308 of FIG. 3

### Keyframe Selection

A mathematical parameter model of a pinhole camera with perspective projection can be used to describe the mapping between the 3D world and the 2D camera image, and to estimate the parameters of the camera model that most approaches the corresponding feature points in each view. By introducing a statistical error model describing the errors in the position of the detected feature points, a Maximum Likelihood estimator can be formulated that simultaneously estimates 1) the camera parameters and 2) the 3D positions of feature points. This joint optimization is called a bundle adjustment.

If the errors in the positions of the detected feature points obey a Gaussian distribution, the Maximum Likelihood estimator has to minimize a nonlinear least squares cost function. In this case, fast minimization is carried out with iterative parameter minimization methods, like the sparse Levenberg-Marquardt method. One difficulty with the iterative minimization is the initialization of the camera parameters and the 3D positions of feature points with values that enable the method to converge to the global minimum. One possible solution is to obtain an initial guess from two or three selected views out of the sequence or sub-sequence. These views are called keyframes. The operation of keyframe selection is illustrated in FIG. 3 by block 310.

Keyframes should be selected with care. For instance, a sufficient baseline between the views is necessary to estimate the initial 3D feature points by triangulation. Additionally, a large number of initial 3D feature points are desirable. Keyframe selection has been overlooked by the computer vision community in the past.

Pollefeys has used the Geometric Robust Information Criterion (GRIC) to evaluate which model, homography (H-matrix) or epipolar geometry (F-matrix), fits better to a set of corresponding feature points in two view geometry. If the H-matrix model fits better than the F-matrix model, H-GRIC is smaller than F-GRIC and vice versa. For very small baselines between the views, GRIC always prefers the H-matrix model. Thus, the baseline will exceed a certain value before F-GRIC becomes smaller than H-GRIC. The disadvantage of this approach is these methods do not select the best possible solution. For instance, a keyframe pairing with a very large baseline is not valued better than a pairing with a baseline that just ensures that the F-matrix model fits better than the H-matrix model. Thus, only the degenerated configuration of a pure camera rotation between the keyframe pairings is avoided. Especially, if the errors in the positions of the detected feature points are high, these approaches may estimate an F-matrix, that does not represent the correct camera motion and therefore provides wrong initial parameters for the bundle adjustment.

The approach of the present method for keyframe selection formulates a new criterion using techniques from stochastic. By evaluating the lower bound for the resulting estimation error of initial camera parameters and initial 3D feature points, the keyframe pairing with the best initial values for bundle adjustment are selected. This embodiment increases the convergence probability of the bundle adjustment significantly.

Then the initial recovery for camera motion and the sparse 3D structure can be performed as illustrated by block 312 in FIG. 3. After a keyframe pairing is selected, the F-matrix between keyframes is estimated by RANSAC using Equation 4 with Equation 2 as a cost function. The estimated F-matrix is decomposed to retrieve initial camera matrices Âₖ₁ and Âₖ₂ of both keyframes. Initial 3D feature points \hat{P}ᵢ′ are computed using triangulation. Now a bundle adjustment between two views is performed by sparse Levenberg-Marquardt iteration using Equation 4 subject to \hat{p}_{i,k1}=Âₖ₁\hat{P}ᵢ′ and \hat{p}_{i,k2}=Âₖ₂\hat{P}ᵢ′ as cost function. The application of the bundle adjustment is illustrated as block 314 in FIG. 3. Initial camera matrices Âⱼ with k1<j<k2, of the intermediate frames between the keyframes are estimated by camera resectioning. Therefore, the estimated 3D feature points \hat{P}ᵢ′ become measurements \tilde{P}ᵢ′ in this step. Assuming the errors mainly in \tilde{P}ᵢ′ and not in \hat{p}_{i,j} the following cost function must be minimized:

$${\overline{μ}}_{res}^{2} = \frac{1}{3 I} {\sum }_{i = 1}^{I} {d ( {\tilde{P}}_{i}^{′} , {\hat{P}}_{i}^{′} )}_{\sum }^{2} ⇒ min \qquad ( 5 )$$

subject to \hat{p}_{i,k1}=Âₖ₁\hat{P}ᵢ′ for all i, where μ̅ᵣₑₛ² is the residual error of camera resectioning.

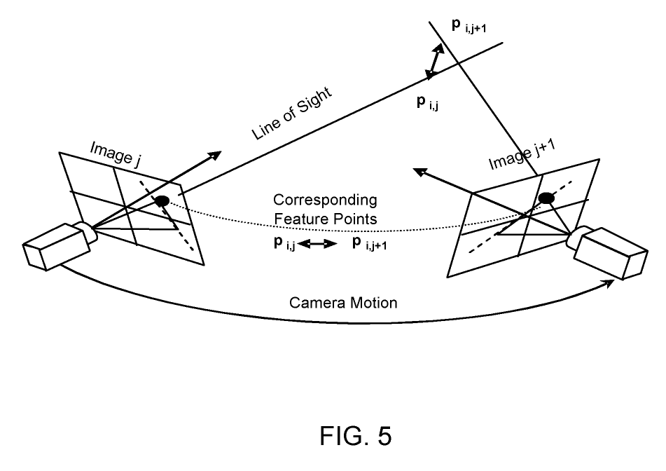

Known camera motion enables the calculation of 3D point coordinates belonging to each inlier correspondence. The triangulation of two lines of sight from two different images gives the 3D coordinate for each correspondence. Due to erroneous detection of feature points, the lines of sight do not intersect in most cases (see FIG. 5). Therefore, a correspondence of two 3D points \tilde{P}_{i,j} and \tilde{P}_{i,j+1} can be determined for each feature point separately. The 3D points are located where the lines of sight have their smallest distance. The arithmetic mean of \tilde{P}_{i,j} and \tilde{P}_{i,j+1} gives the final 3D coordinate Pi.

### Bundle Adjustment

The final bundle adjustment step optimizes all cameras ̂Aj and all 3D feature points ̂Pi of the sequence by sparse Levenberg-Marquardt iteration, with

$${\overline{v}}_{res}^{2} = \frac{1}{2 IJ} {\sum }_{j = 1}^{J} {\sum }_{i = 1}^{I} {d ( {\tilde{p}}_{i , j} , {\hat{A}}_{j} {\hat{P}}_{i}^{′} )}_{\sum }^{2} ⇒ min \qquad ( 6 )$$

where v̅ᵣₑₛ is the residual error of bundle adjustment. The applied optimization strategy is Incremental Bundle Adjustment. First, Eq. (6) is optimized for the keyframes and all intermediate views with the initial values determined in the previous step. Then the reconstructed 3D feature points are used for camera resectioning of the consecutive views. After each added view, the 3D feature points are refined and extended and a new bundle adjustment is carried out until all cameras and all 3D feature points are optimized.

Some approaches used to recover camera motion parameters and sparse 3D feature positions have just been described. However, only a few scene points are reconstructed from feature tracking. Obtaining a dense reconstruction may be achieved by interpolation, but in practice this does not yield satisfactory results. Small surface details are not effectively reconstructed in this way. Additionally, some important features are often missed during the corner matching and are therefore unlikely to appear in an interpolated reconstruction. These problems can be avoided by using algorithms which estimate correspondences for almost every point in the images. Because the reconstruction was upgraded to metric, methods that were developed for calibrated stereo rigs can be used.

Rectification can then be applied to accumulated data. Since the system and method has computed the calibration between successive image pairs, the epipolar constraint that restricts the correspondence search to a 1-D search range can be exploited. It is possible to re-map the image pair to standard geometry with the epipolar lines coinciding with the image scan lines. The correspondence search is then reduced to a matching of the image points along each image scan-line. This results in a dramatic increase of the computational efficiency of the algorithms by enabling several optimizations in the computations.

### Dense Stereo Map Estimation

While a 3D scene can be theoretically constructed from any image pairs, due to the errors from the camera motion estimation and feature tracking, image pairs with small baseline distances will be much more sensitive to noise, resulting in unreliable 3D reconstruction. In fact, given the same errors in camera pose estimation, bigger baselines lead to smaller 3D reconstruction error.

Accordingly, it is valuable to improve reliability and resolution by using multiple image pairs. Instead of using single image pairs for a 3D point reconstruction, an embodiment of the system and method uses image pairs of different baseline distances. This multi-frame approach can help reduce the noise and further improve the accuracy of the 3D image. Our multi-frame 3D reconstruction is based on a simple fact from stereo equation:

$$\frac{Δ d}{B} = \frac{f}{Z} = f * \frac{1}{Z} = λ .$$

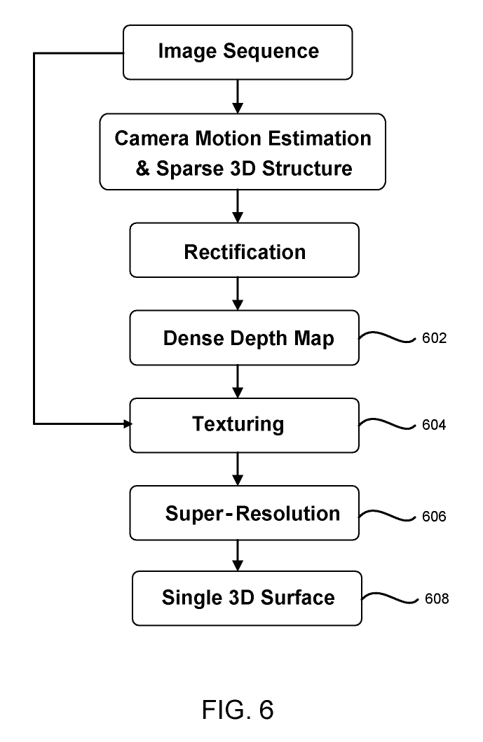

This equation indicates that for a particular data point in the image, the disparity Δd divided by the baseline length B is constant since there is only one distance Z for that point (f is focal length). If any measure of matching for the same point is represented with respect to λ, it should consistently show a good indication only at the single correct value of λ. independent of B. Therefore, if we fuse such measures from image pair with multiple baselines (or multi-frames) into a single measure, we can expect that it will indicate a unique match. This results in a dense stereo map estimation as illustrated in FIG. 6 by block 602.

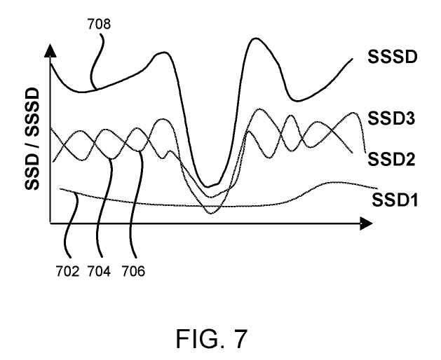

The SSD (Sum of Squared Difference) over a small window is one of the simplest and most effective measures of image matching. Note that these SSD functions have the same minimum position that corresponds to the true depth. We add up the SSD functions from all stereo pairs to produce the sum of SSDs, called SSSD (Stereo Sum of Squared Difference) that has a clear and unambiguous minimum. FIG. 7 illustrates that multiple SSDs 702-706 can be added up to form the SSSD 708.

The dense stereo maps as computed by the correspondence linking can be approximated by a 3D surface representation suitable for visualization and measurement. So far each object point has been treated independently. To achieve spatial coherence for a connected surface, the depth map is spatially interpolated using a parametric surface model. The boundaries of the objects to be modeled are computed through depth segmentation. In the first step, an object is defined as a connected region in space. Simple morphological filtering removes spurious and very small regions. A bounded thin plate model can be used with a second order spline to smooth the surface and to interpolate small surface gaps in regions that could not be measured. If the object consists of dominant planar regions, the local surface normal may be exploited to segment the object into planar parts. The spatially smoothed surface is then approximated by a triangular wire-frame mesh to reduce geometric complexity and to tailor the anatomical model.

Texture fusion can also be applied to the model as illustrated by block 604 (FIG. 6). Texture mapping onto the wire-frame model greatly enhances the realism of the models. As a texture map, one could take the texture map of the reference image only and map it to the surface model. However, this creates a bias towards the selected image, and imaging artifacts like sensor noise, unwanted specular reflections or the shadings of the particular image are directly transformed onto the object. A better choice is to fuse the texture from the image sequence in much the same way as depth fusion.

Viewpoint linking builds a controlled chain of correspondences that can be used for texture enhancement. A texture map in this context is defined as the color intensity values for a given set of image points, usually the pixel coordinates. While depth is concerned with the position of the correspondence in the image, texture uses the color intensity value of the corresponding image point. For each reference image position, a list of color intensity values can be collected from the corresponding image positions in the other viewpoints. This allows for enhancement of the original texture in many ways by accessing the color statistics. Some features that can be derived naturally from the texture linking algorithm are described below. The spatial window over which the chain of correspondences is applied may vary depending on the statistical method used or the internal anatomical structure being examined.

Super-resolution texture can also be provided as in block 606 of FIG. 6. The correspondence linking is not restricted to pixel-resolution, since each between-pixel position (or sub-pixel position) in the reference image can be used to start a correspondence chain as well. Color intensity values can then be interpolated between the pixel grid. When the object is observed from many different view points and possibly from different distances, the finite pixel grid of the images for each viewpoint is generally slightly displaced. This displacement can be exploited to create super-resolution texture by fusing all images on a finer re-sampling grid. The super-resolution grid in the reference image can be chosen to be arbitrarily fine, but the measurable real resolution of course depends on the displacement and resolution of the corresponding images. For example, some embodiments may use 2-32 subsamples between each pixel.

Given two or more 3D surfaces from the same object captured from different directions with partial overlapping, the present method can bring those surfaces into the same coordinate system (i.e., common coordinate system) and form an integrated 3D model as in block 608. One elegant method of combining the surfaces is called Iterative Closest Point (ICP) algorithm and is very effective in registering two 3D surfaces. The idea of the ICP algorithm is: given two sets of 3D points representing two surfaces called Sⱼ and Sⱼ₊₁, find the rigid transformation as defined by rotation R and translation T, which minimizes the sum of Euclidean square distances between the corresponding points of Sⱼ and Sⱼ₊₁. The sum of all square distances gives the surface matching error:

$$e ( R , T ) = {\sum }_{K}^{N} \vert ( {Rp}_{k} + T ) - {x}_{k} {‖}^{2} , {p}_{k} ∈ {S}_{j} and {x}_{k} ∈ {S}_{j + 1} .$$

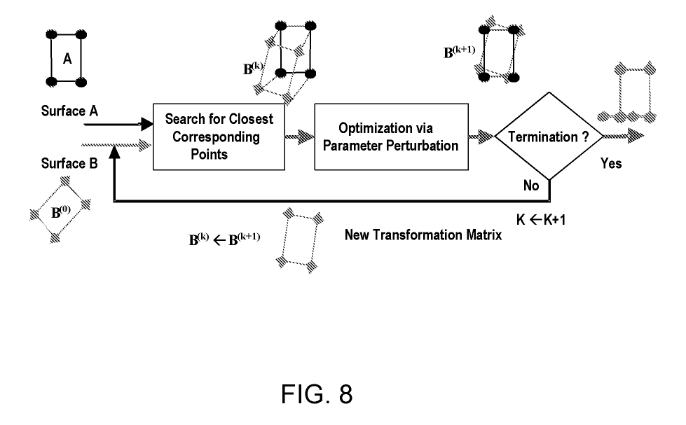

By iteration, optimum R and T are found to minimize the error e(R, T). In each step of the iteration process, the closest point s_{k,j} on Sⱼ and s_{k,j+1} on Sⱼ₊₁ is obtained by effective search such as k-D tree partitioning method. FIG. 8 shows the iterative fine alignment optimization process. After an integrated 3D model is produced, proper 3D compression technique is used to clean up the data and reduce its size for 3D visualization and diagnosis uses.

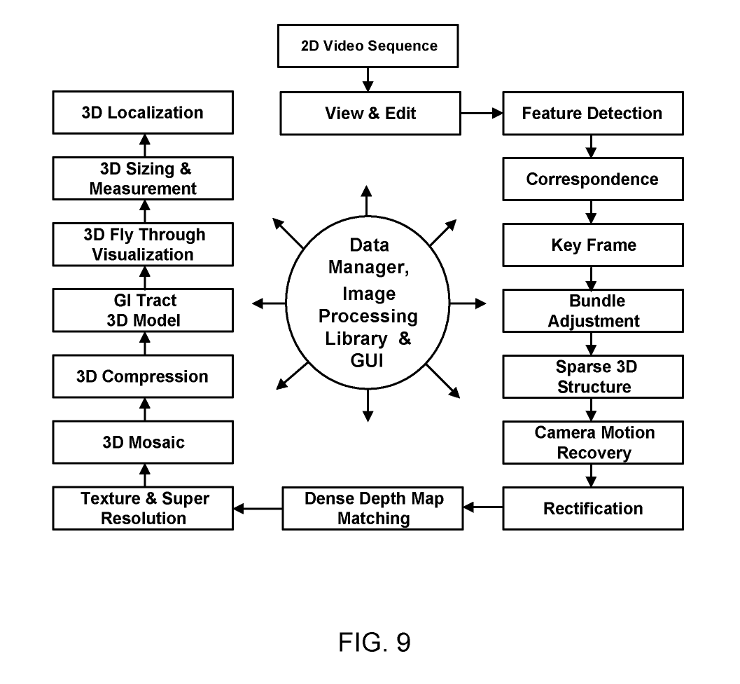

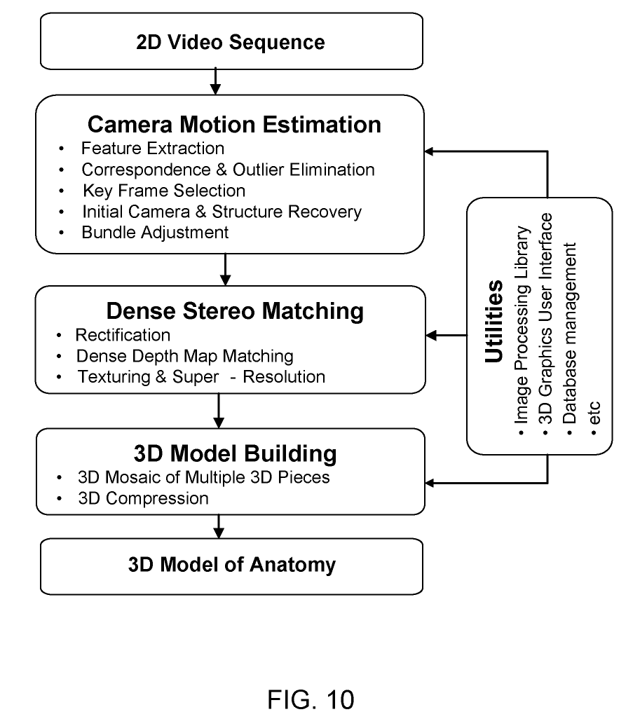

FIG. 9 illustrates major functional components of a system for processing 2D video to a 3D environment. These functional components can be contained in separate software modules or combined together in groups as implementation best dictates. For example, the major software modules may be grouped into 4 groups as illustrated in FIG. 10 and the groups can be: (1) camera motion estimation; (2) dense depth map matching; (3) building the 3D model; and (4) basic processing functions and utilities.

While these functional modules may be implemented in software, the functionality may also be implemented in firmware or hardware. In addition, the software may reside entirely on a single computing workstation or the application can be deployed in a web application environment with a central processing server.

Once the 3D model has been created using a computing platform such as a server or workstation computer, then the model can be displayed on a display screen for viewing by an end user or physician. A virtual camera can be provided in a software application used with the physical display. The virtual camera can enhance the 3D visualization of the super-resolution, textured video model by enabling the end user to perform a 3D fly-through of the 3D model and enable zoom-in capability on any portion of the model. This capability can speed up a physician's visualization and diagnosis. As a result, the overall diagnosis can be improved because physicians can more easily visualize unusual structures and this means the diagnosis will be more accurate and complete.

In one embodiment, a 3D sizing of selected pathological structures can take place to enable a physician to determine the size, degree and stage of a visible disease. With an accurate 3D model, a doctor can measure the size of any suspect areas. This is possible with a 3D model because dimensional information cannot be provided via 2D images alone. Then possible disease features can be selected and tagged on the 3D model to enable a reviewing physician to quickly locate marked candidate area locations that may be diseased on the 3D model. This type of marking can expedite quantitative analysis of target pathological structures in an on-the-fly search for such marked locations.

In order to select which features may be pathological, the system and method can include a feature comparison method that compares the visual feature of captured topology or image with a structure and/or image database containing structures or images that are typically suspected of illnesses. If the similarity is high, the system can tag this section of the image for a doctor to review in further detail.

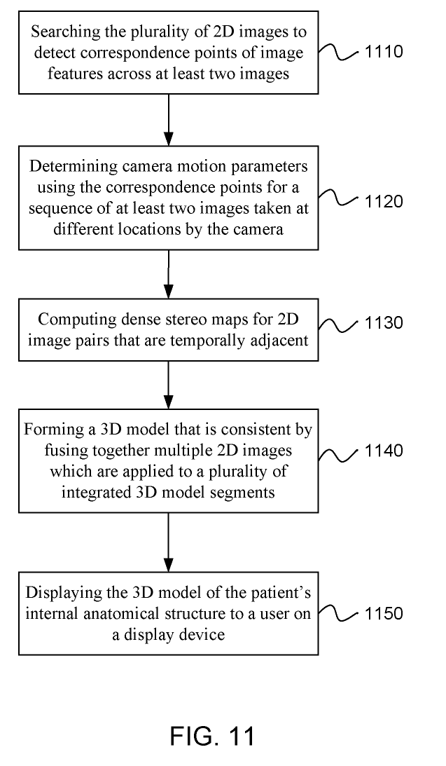

FIG. 11 is a flowchart summarizing an embodiment of a method of generating a three dimensional (3D) model of an anatomical structure of a patient using a plurality of two dimensional (2D) images acquired using a camera. The method includes the operation of searching the plurality of 2D images to detect correspondence points of image features across at least two images, as in block 1110. Camera motion parameters can be determined using the correspondence points for a sequence of at least two images taken at different locations by the camera moving within the internal anatomical structure, as in block 1120. The camera motions may be estimations that are accurate enough for building the 3D model.

Dense stereo maps for 2D image pairs that are temporally adjacent can then be computed, as in block 1130. Multiple image pairs of different baseline distances can be used for 3D point reconstruction, as opposed to using single image pairs. The multi-frame approach can reduce noise and improve the accuracy of the 3D image. A consistent 3D model can be formed by fusing together multiple 2D images which are applied to a plurality of integrated 3D model segments, as in block 1140. This results in a 3D model which represents the patient's internal anatomy with textures that are created from the actual pictures taken by a capsule camera or similar endoscopic device.

Then the 3D model of the patient's internal anatomical structure can be displayed to a user on a display device, as in block 1150. The display device maybe a computer monitor, projector display, hardware 3D display, or another electronic display that a user can physically view. As discussed previously, this enables the end user, such as a doctor, to navigate through the 3D model in any direction to view the model of the patent's internal anatomy.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for generating a three dimensional (3D) model of an internal anatomical structure of a patient using a plurality of two dimensional (2D) images acquired using a camera, comprising the steps of:
searching the plurality of 2D images to detect correspondence points of image features across at least two images;
determining camera motion parameters using the correspondence points for a sequence of at least two 2D images taken at different locations by the camera moving within the internal anatomical structure;
computing dense stereo maps for 2D image pairs that are temporally adjacent;
forming a 3D model that is consistent by fusing together multiple 2D images which are applied to a plurality of integrated 3D model segments; and
displaying the 3D model of the patient's anatomical structure to a user on a display device.

2. The method of claim 1, wherein the step of searching the plurality of 2D images further comprises:
searching each 2D image for feature points; and
searching across subsequent frames to detect correspondence points between each 2D image and subsequent 2D images.

3. The method of claim 1, further comprising the step of capturing the 2D images using a capsule camera configured to travel through the internal anatomical structure.

4. The method of claim 1, wherein the step of estimating camera motion parameters comprises the step of representing a capsule camera using a pin-hole camera model to describe a projection of a 3D point P to an image coordinate p through a perspective camera and a 2D image feature point defined by p=(x, y, 1).

5. The method of claim 1, wherein the step of estimating camera motion parameters comprises the steps of:
selecting keyframes suited for analysis of structure and motion recovery data; and
utilizing intrinsic parameters of a capsule camera to avoid problems relating to critical camera sequences.

6. The method of claim 1, further comprising the step of selecting keyframes by evaluating a lower bound for the resulting estimation error of initial camera parameters and initial 3D feature points selected from the correspondence points.

7. The method of claim 1, wherein the step of calculating dense stereo maps further comprises the steps of:
selecting multiple image pairs with different base line distances;
selecting multiple frame image pairs having minimized camera motion errors in order to improve accuracy of the 3D images; and
computing dense stereo image maps between selected multiple image pairs.

8. The method of claim 1, wherein the step of calculating the dense stereo maps comprises:
creating an approximate 3D surface representation of the dense stereo maps suitable for visualization; and
utilizing a parametric surface model in order to achieve spatial coherence for a connected surface of a depth map.

9. The method of claim 1, further comprising the step of providing 3D sizing of selected pathological structures to enable a physician to determine the size, degree and stage of a visible disease.

10. The method of claim 1, wherein the 2D image pairs are taken at different times.

11. A method for generating a 3D model from a plurality of 2D images, comprising the steps of:
initiating a 2D image salient feature search for a first image to identify correspondence points between the first image and subsequent 2D images;
calculating camera motion parameters from subsequent 2D images using correspondence points between the first 2D image and subsequent 2D images;
performing key frame selection procedures utilizing stochastic analysis to lower camera error parameters and enhance 3 D positions of feature points to thereby significantly increase the convergence probability of a bundle adjustment and computation of dense depth maps with increased accuracy;
forming a 3D model that is consistent by fusing together multiple 2D images which are applied to a plurality of integrated 3D model segments; and
generating texture fusion for textures applied to the 3D model utilizing the 2D image sequence and the computed dense depth map data in order to enhance realism of the 3D model.

12. The method of claim 11, further comprising the step of determining 3D sizing of selected pathological structures to enable a physician to determine the size, degree and stage of a detected disease.

13. The method of claim 11, further comprising the step of tagging selected pathological structures on the 3D model to enable a reviewing physician to quickly locate marked candidate area locations on the 3D model to expedite quantitative analysis of target pathological structures.

14. The method of claim 11, further comprising the step of enhancing 3D visualization of 3D model with 3D fly-through virtual camera zoom-in capability to provide visualization and diagnosis.

15. A method for generating a three dimensional (3D) model of a patient's internal anatomical structure by analyzing a plurality of 2D images acquired using a camera, comprising the steps of:
searching the plurality of 2D images to detect correspondence points of image features across at least two 2D images;
estimating camera motion parameters using the correspondence points for a sequence of at least two images taken at different times and locations by the camera moving within the internal anatomical structure;
determining 3D model points by triangulation using an average of two lines of sight from at least two 2D images;
computing dense stereo maps between 2D image pairs that are temporally adjacent by fusing a matching measure from the image pair with multiple baselines from multiple 2D images into a single matching measure;
applying a texture map that is fused together from a plurality of 2D images related to the 3D model point; and
displaying the 3D model of the patient's internal anatomical structure to a user on a display device.

16. The method of claim 15, wherein the step of computing dense stereo maps is performed using the Sum of Squared Difference (SSD) over a defined window to determine measures of image matching with an unambiguous minimum representing depth.

17. The method of claim 15, wherein the step of calculating dense stereo maps further comprises the steps of:
selecting multiple image pairs with different base line distances;
selecting multiple frame image pairs having minimized camera motion errors in order to improve accuracy of the 3D images; and
computing dense stereo image maps between selected multiple image pairs.

18. The method of claim 15, wherein the step of estimating camera motion parameters comprises the step of selecting keyframes suited for analysis of structure and motion recovery data by evaluating a lower bound for the resulting estimation error of initial camera parameters and initial 3D feature points.

19. The method of claim 15, further comprising the step of interpolating the dense stereo maps for depth in a spatial orientation using a parametric surface model.

20. The method of claim 15, further comprising the step of integrating a plurality of 3D surfaces from an object captured from different directions with partial overlapping by using the Iterative Closest Point (ICP) method.
